(19) United States
(12) Patent Application Publication
(10) Pub. No.: US 2009/0079743 A1
(43) Pub. Date: Mar. 26, 2009

(54) DISPLAYING ANIMATION OF GRAPHIC OBJECT IN ENVIRONMENTS LACKING 3D REDNDERING CAPABILITY

(75) Inventors: Douglas Pearson, Seattle, WA (US); Lynnette Lines, Seattle, WA (US); Jason Gholston, Renton, WA (US); Kristen Van Dam, Seattle, WA (US)

Correspondence Address: LAW OFFICES OF RONALD M ANDERSON, 600 108TH AVE, NE, SUITE 507, BELLEVUE, WA, 98004, US

(73) Assignee: Flowplay, Inc., Seattle, WA (US)

(21) Appl. No.: 11/858,567

(22) Filed: Sep. 20, 2007

(51) Int. Cl. G06T 13/00

(52) U.S. Cl. 345/473

(57) ABSTRACT

Three dimensional (3D) animations of an avatar graphic object are displayed in an environment that lacks high quality real-time 3D animation rendering capability. Before the animation is displayed in the environment at runtime, corresponding 3D and 2D reference models are created for the avatar. The 2D reference model is provided in a plurality of different views or reference angles. A 3D animation rendering program is used to produce 3D motion data for each animation. The 3D motion data define a position and rotation of parts of the 3D reference model. Image files are prepared for art assets drawn on associated parts of the 2D reference model in all views. At runtime in the environment, the position, rotation, and layer of each avatar part in 3D space is mapped to 2D space for each successive frame of an animation, with selected art assets applied to the associated parts of the avatar.

### BACKGROUND

Browser programs such as Apple Corporation's SAFARI™, Mozilla's FIREFOX™, and Microsoft Corporation's INTERNET EXPLORER™ enable users to readily access information and other content available on the Internet. Virtually every personal computer user who frequently accesses the Internet is very comfortable using such programs. Thus, it is not surprising that most people would prefer to participate in social interactions, for example, within a virtual environment, and play online games from within a browser program rather than installing and running separate software applications for this purpose. However, although web pages that include eXtended Markup Language (XML) content can provide a remarkably interactive experience for users, there are still limitations inherent in the browser program paradigm that can impact on the quality of graphic displays. For example, computer graphics used in games that run as standalone programs on the personal computer or game machines can be remarkably lifelike in the way that they enable the display of three-dimensional (3D) animation characters and other graphic objects within the games. In 3D virtual environment games, it is common to enable a user to select one of several different characters to represent the user in the game, and these characters are then rendered in 3D format as they move in selected animations within a virtual environment of the game.

Characters representing players in games or in other types of virtual environments are referred to as “avatars.” Generally, avatars displayed in 3D animations are limited to use in dedicated software programs and are not employed in web pages accessed by a web browser program, because the 3D animation of avatars in a browser program would be difficult to achieve in the same manner and with the same quality as in dedicated programs that have built-in rendering engines. In contrast, avatars appearing in web pages accessed with a browser program typically appear only in two-dimensional (2D) animations and only in one or two orientations (e.g., in a front view and/or a side view).

A character can be animated by creating and displaying a plurality of successive frames in rapid sequence, like the frames of a movie. Once the frames have been created for an animation of an avatar, the prepared frames showing the avatar in successive different positions can be displayed at run time to create an animated effect. For display in 2D environments such as in a browser program, the process of creating multiple frames for a given animation must be redone for each avatar that appears different in appearance, for example, for each different type of avatar including male and female avatars, and for each different clothing/hairstyle that is selectively used for the avatars. Each outfit (or set of clothes) that the character can wear and each hairstyle must be individually rendered in each frame of an animation. The effort required to create animations in this manner is proportional to the number of outfits/hairstyles multiplied by the number of animations. In a system that enables a player to select an arbitrary combination of clothes (e.g., a combination of a hat, a shirt, pants, a pair of shoes, and a jacket), a catalog of just 10 hats, 10 shirts, 10 pants, 10 shoes and 10 jackets provides 10̂5 or 100,000 possible different clothing combinations. If there are 20 possible animations, it would be necessary to create 20*100,000 or 2,000,000 sets of animated frames, which is clearly impractical. Therefore this approach is generally only used in applications where either there is little animation of the avatars, or there are very few possible outfits/hairstyles that an avatar can wear. Otherwise, the labor costs required for creating each of the frames used in the animations would be prohibitively expensive.

The second common solution to this problem, which is typically used in games played on a computing device, is to render each animated frame at runtime using a full 3D rendering engine running within the game software. This approach draws each element of the avatar's clothes in the correct position in response to a set of 3D animation data. Each piece of clothing is created as part of a 3D model and rendered at runtime to produce the animation. While this approach is very effective, it requires a powerful graphical engine. At the present time, 3D engines that are able to run in real-time inside a web browser can only render one or two hundred polygons in 3D animations. In contrast, a high quality 3D animation for a single avatar might require real-time rendering of more than 5,000 polygons and this number would increase linearly for each additional avatar appearing on the screen at the same time. Thus, currently available 3D rendering engines for the browser program environment are unable to produce such high quality rendered images for 3D animations and are therefore impractical for this purpose.

Clearly, it would be desirable to provide an approach that greatly simplifies the task of enabling a number of different 3D animations for avatars or other graphic objects within a browser program or other environment, where each graphic object or avatar can have many different appearances. Further, it would be desirable to provide a higher quality and more realistic 3D appearance for avatars animated within a 2D display of a virtual environment or in an online game accessed within a browser program or other type of environment with limited capability for displaying animations. The same approach should also be useful in displaying other types of graphic objects that represent similar problems due to the variety of display options and number of animations of the graphic objects that are available.

### SUMMARY

Accordingly, a novel method has been developed that addresses the problem discussed above. The method enables animations of a graphic object, which can have multiple different visual appearances, to be displayed in a 2D form in an environment lacking support for high quality real-time 3D rendering of the graphic object. In this method, the graphic object includes a plurality of associated parts to which different art assets can be selectively applied to change the appearance of the graphic object. Prior to displaying an animation in the environment lacking support for high quality real-time 3D rendering, a 3D reference model for the graphic object is created. Similarly, multiple views of a 2D reference model are created for the graphic object. Each of the multiple views of the 2D reference model illustrate the 2D model when viewed from a different direction (e.g., front, rear, left and right sides, and left and right ¾ views). The 2D reference model and the 3D reference model are then exactly aligned with each other. Next, 3D motion data are created for each animation of the graphic object desired, using the 3D reference model. This step can be carried out with readily available 3D animation software. Generally, each animation that is created will include a plurality of frames in which specific associated parts of the 3D reference model assume different positions and orientations or rotations. For each art asset that might be displayed on the graphic object at runtime, 2D image files are provided for all of the multiple views of the associated parts of the 2D reference model. These 2D image files illustrate each of the art assets on the associated parts of the 2D reference model, as they will appear when the graphic object is displayed at runtime.

Subsequently, the 3D motion data and 2D image files are used when displaying an animation selected from the desired animations in the environment that lacks 3D rendering capability. The method further provides for mapping the 3D motion data for each associated part of the graphic object in each frame of the animation, to a corresponding 2D location for the 2D reference model in the frame. Successive frames of the animation selected are rendered in the environment, so that for each frame of the animation selected, the associated parts of the graphic object are displayed as the 2D reference model with the art assets applied. Each associated part is displayed at a mapped position and at a mapped rotation for the frame determined from the 3D motion data. The successive frames are displayed in rapid succession to produce the animation.

In at least one exemplary embodiment of the method, a user can select different portions of the art assets to be displayed on specific associated parts of the graphic object. The art assets that are selected can thus be employed to customize an appearance of the graphic object when the animation of the graphic object is displayed in the environment. Further, the art assets that are selected can be displayed in different layers on the associated parts of the graphic object. Also, an area of one art asset displayed on one layer that is further from a view point can be hidden with an art asset that is displayed on a different layer that is closer to the view point. In addition, the method enables the art assets to be applied to an associated part of the graphic object in different layers that are ordered in regard to the view point. Thus, an art asset applied to an associated part on a layer that is closer to the view point hides at least part of an art asset applied to that part on a layer that is further from the view point.

For each frame of the animation that is being displayed, an exemplary embodiment of the method includes several steps. These steps include identifying a view point for the animation selected in 3D space, and determining a position of the graphic object in 3D space. For each associated part of the graphic object taken in succession, the location and the rotation of the associated part are input or obtained from the 3D motion data. Coordinates in 3D space for the associated part are then projected into 2D space, to determine a layer in which the associated part should be displayed in the environment. Using the rotation for the associated part, a closest reference angle is determined for the associated part. An affine transformation matrix then determines how the associated part is drawn on the display screen. The associated parts and the layers in which the associated parts are disposed can be sorted, based on a distance between the associated parts and the view point. For each layer in succession, the associated parts of the graphic object are displayed in the layer with selected art assets applied, art assets on a layer that is further from the view point can be hidden by art assets on a layer that is closer to the view point. The affine transformation matrix can be employed to determine the position and the rotation of each associated part in each layer when the associated part is drawn on the display screen.

While it is not intended that this exemplary method be limited to a specific type of graphic object, in an initial application of the novel approach, the graphic object can be an avatar. Further, the environment in which the animation is displayed can comprise a browser software program. In one exemplary application of this novel approach, the art assets include a plurality of different types and articles of clothing that can be different in appearance and style. Various types and different articles of clothing included in the art assets enable a user to selectively customize an appearance of the avatar when the avatar is rendered and displayed in the environment as a 2D graphic object. For example, a user can select a specific style of shirt, pants or skirt, a style of shoes, and a hat to be applied to the avatar. The avatars that are used for the animations can be male or female (each type requires a corresponding set of 3D motion data, since different 3D and 2D reference models are used for each sex/type of avatar). There can thus be many different possible combinations of articles of clothing/types of avatars, but the present novel approach readily enables an avatar that appears to be wearing selected articles of clothing and a selected hairstyle to be animated in a 2D space without the need for real-time 3D rendering, or drawing the avatar with each possible combination of clothing. Also, the art assets can further include a plurality of different facial features, such as hair styles, which can be selected to further customize the appearance of the avatar. Other facial features include noses, eyes, head shapes, skin color, etc.

This novel approach is very extensible, since it enables new articles of clothing to be added to the art assets for use in displaying any animation selected from the desired animations without modifying the 3D motion data that have been created, since the 3D motion data are independent of the art assets. Similarly, the novel method also enables new animations to be employed to create additional 3D motion data for use with any of the art assets.

Another aspect of this novel approach is directed to a memory medium on which are stored machine instructions for enabling functions generally consistent with the steps of the method to be carried out, given that creation of the 3D model data and multiple views of the 2D reference model, with the art assets drawn on the parts of the graphic object in all of the multiple views have already been done. Other aspects of the techniques are directed to a system including a memory in which machine instructions and data are stored, a display for displaying graphics and text, an input device for providing an input for controlling the system, and a processor that is coupled to the memory, the display, and the input device. In at least one such exemplary system, the processor executes the machine instructions to carry out a plurality of functions that are generally consistent with the steps of the method that are carried out before the animations are to be displayed in the environment that lacks the capability for 3D rendering, while in at least another exemplary system, the machine instructions cause the processor to carry out the steps that are consistent with displaying the animations in the environment at runtime.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a flowchart illustrating exemplary logical steps for enabling an animation to be displayed in an environment that lacks 3D rendering capability, in accord with the present novel approach;

FIG. 2 is an exemplary 3D reference model for a female avatar;

FIG. 3 is a front view of an exemplary 2D reference model exactly corresponding to the 3D reference model of FIG. 2;

FIGS. 4A-4F illustrate six exemplary difference views or reference angles for the 2D reference model of FIG. 3;

FIG. 5 illustrates the alignment of pivot points in the exemplary 3D and 2D reference models of FIGS. 2 and 3 (but only showing the front view of the 2D reference model);

FIG. 6 illustrates two initial frames of an animation of the 3D reference model, showing an exemplary approach for creating 3D motion data;

FIG. 7 illustrates a blouse that represents one article of clothing that can be selected for the avatar of FIG. 3, showing how a plurality of image files are created for different parts of the avatar when wearing the blouse;

FIGS. 8A-8F illustrate how the blouse of FIG. 7 is drawn on the avatar for each of the six different views or reference angles;

FIG. 9 is a flowchart illustrating exemplary steps employed in the runtime rendering of a graphic object 3D animation in the environment lacking high quality real-time 3D animation rendering capability, according to the present novel approach;

FIG. 10 is a schematic diagram of an exemplary network showing how a server communicates data with a user's computer to enable the user's computer to render an animation of a graphic object in an environment such as a browser program, which does not support 3D animation rendering; and

FIG. 11 is functional block diagram of a computing device that is usable for either a server that provides the 3D motion data and art asset files, or for a personal computer of a user that is used for rendering the 3D animation in a 2D environment, at runtime.

### DESCRIPTION

### Figures and Disclosed Embodiments are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

### Overview of the Procedure for Creating a 3D Animation of a Graphic Object

A core concept of the present novel approach is that a graphic object, such as an avatar, is modeled in both 2D and 3D, and that both models exactly correspond to each other. One application of this approach animates avatars in a virtual environment that is accessed over the Internet using a conventional browser program. As more generally noted above, an avatar is a virtual character that typically represents a user within a virtual world, usually has a humanoid form, wears clothes, and moves about in the virtual world. However, it must be emphasized that the present approach is not intended to be limited only for use in animating avatars in a virtual environment, since the approach can readily be beneficially applied to enabling a 3D animation of almost any type of graphic object that may have a plurality of different appearances. For example, the same approach might be used in connection with vehicles employed in a computer game or other virtual environment that is presented in an environment lacking high quality real-time 3D animation rendering capability. Furthermore, although the initial application of the technique was intended to enable a 3D animation to be rendered and displayed within a browser program lacking a high quality real-time 3D animation rendering engine, the specific environment in which such an animation is displayed is not intended to be limited to browser programs. Instead, a 3D animation of a graphic object might be rendered and displayed in almost any program that can display graphic objects in 2D space, but lacks a sufficiently powerful 3D animation rendering engine (i.e., in what is sometimes referred to herein as a “limited environment”).

Another key concept in the present approach is that several steps of the process are carried out before there is a need to render and display the 3D animation in a limited environment. Thus, in one exemplary approach, the preliminary steps include animating a 3D model of the graphic object using an appropriate 3D animation tool. The MAYA™ program of Autodesk, Inc. was used for this purpose in an initial exemplary embodiment of the present approach, but there are several other software 3D animation tools that can alternatively be employed for this purpose. For each different animation desired, the motion of each body part (or more generally—of each movable portion of the graphic object) produced by the animation tool is captured in a data file. The resulting data are referred to herein as the “3D motion data” of an animation. The 3D motion data are subsequently used when the animation is implemented at runtime in the limited environment, to move the body part of the 2D reference model on which a selected art asset is applied (i.e., using the art asset image files). The 2D part that is moved corresponds to the same body part of the 3D reference model, and the appropriate view or reference angle of the 2D reference model is used for each frame of the animation displayed at runtime.

### Art Assets

The term “art asset” as used herein refers to one or more graphical images or features that can be applied to one or more parts of a 2D reference model to change its appearance, e.g., by drawing a portion of an article of clothing on one or more parts of the 2D reference model. The images are stored in art asset image data files (one for each associated part of a graphic object) for each art asset that may be rendered in an animation at runtime. The position and orientation of each part of the 2D reference model having an art asset is computed from the 3D coordinate data stored in the 3D motion data file for a specific animation that is to run. Each such part will be rendered on a display screen during the runtime display within the limited environment. This approach enables the 3D motion data for each desired animation to be kept separate from the 2D image data for each different art asset.

Any number of different art assets can be used with each animation, since the 3D motion data are independent of the art asset image data. The art assets can comprise specific articles of clothing for an avatar, or different hair styles that can be selected by a user for changing an appearance of the avatar when it is animated in a limited environment. More generally, the art assets can comprise sets of almost any feature that changes the appearance of a graphic object when drawn on one or more parts of the 2D reference model for the graphic object with which the art asset is associated. This separate relationship between the 3D motion data for each animation and the art assets that are applied to the different views of the 2D reference model means, for example, that many different articles of clothing (e.g., many different styles and appearances of shirts, pants, coats, shoes, etc.) can be selectively applied to the 2D reference model when the avatar is animated in the limited environment, and each selected article of clothing will animate correctly at runtime without having to create animation frames for each different shirt, or other articles of clothing applied. The present novel approach thus avoids the scaling problems of the conventional approach described above in the Background section that might require millions of different frames to be prepared to cover all possible combinations of articles of clothing, types of avatars, and for all animations.

In the present novel approach, the runtime playback of a selected animation in a limited environment only requires mapping a single 3D point into 2D space for each body part (i.e., for each separate portion of a graphic object), drawing a 2D image at that location using existing 2D image files for the selected art assets, and applying an affine transformation to rotate and scale the 2D image. This novel approach vastly reduces the computational power required and enables each selected 3D animation to play back inside web browsers or other limited environments that do not include a 3D animation rendering capability.

### Further Details of the Novel Process

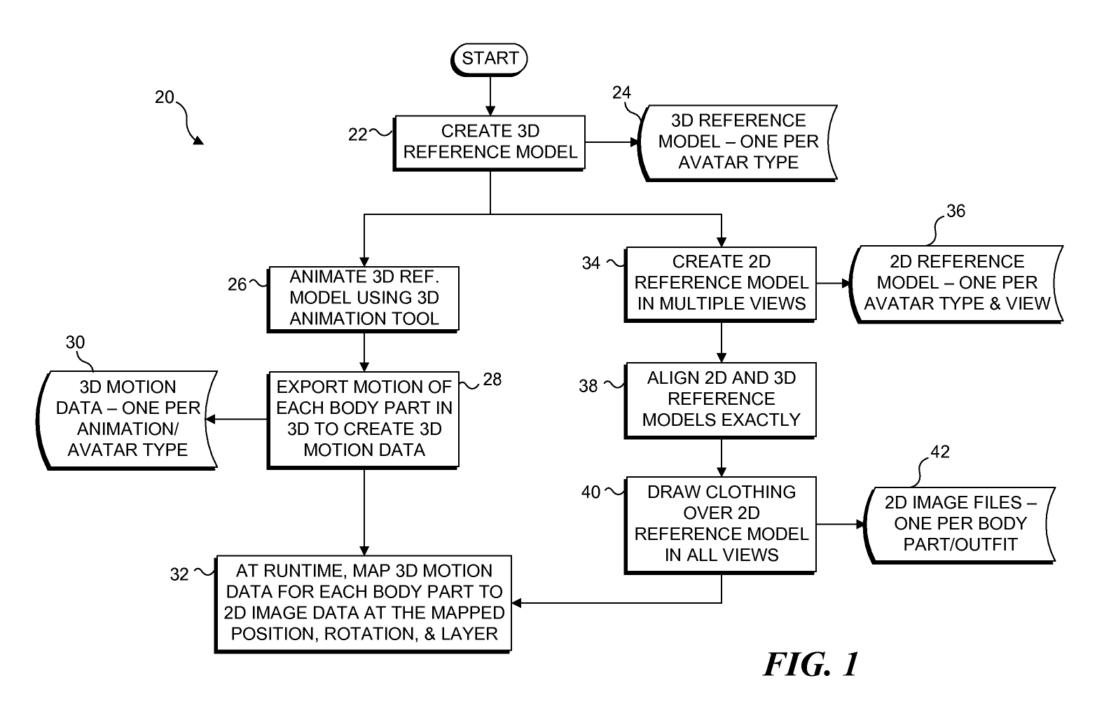

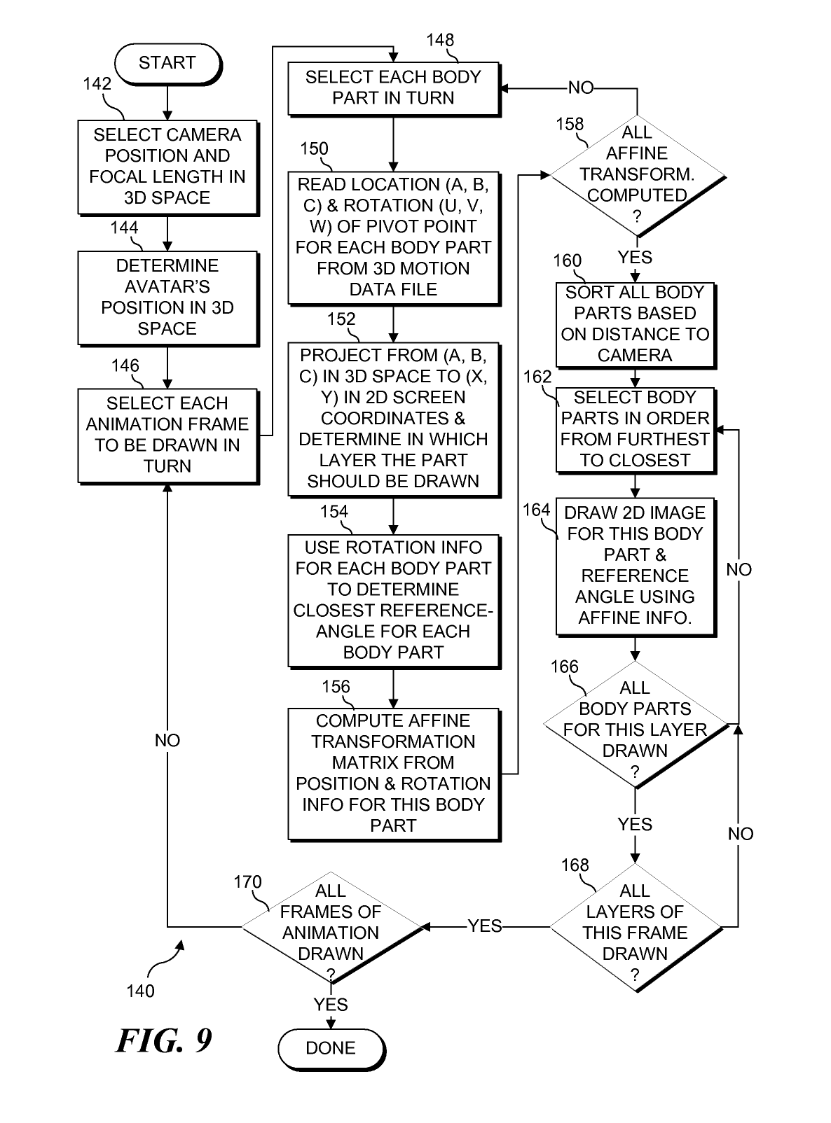

FIG. 1 illustrates a flowchart 20 showing the steps carried out in an exemplary embodiment of the present approach. In this flowchart, all of the steps except a step 32 are carried out prior to rendering and displaying a 3D animation of a graphic object in an environment lacking a high quality real-time 3D animation rendering capability. The details of step 32 are discussed below, in connection with FIG. 9. After starting the preliminary portion of the process, a step 22 creates a 3D reference model 24 for each type of avatar or graphic object for which an animation will be displayed. For example, a separate 3D reference model would be created for each of a male avatar and a female avatar, since they are different in form. Alternatively, it would be possible to create a single unisex avatar, but the results would be less realistic. As a further option to enhance reality, multiple 3D reference models can be created for each gender, each different 3D reference model for a gender having a different physique. For example, a male avatar 3D reference model might created having broad shoulders and a thin waist, another with average shoulders and waist, and still another that appears overweight.

A step 26 provides for running a 3D animation tool to animate the 3D reference model for each animation that is desired. As noted above, the commercially available MAYA™ 3D animation tool was used in an exemplary embodiment. In a step 28, the motion of each body part (or separately movable portion of a graphic object) that moves in a 3D animation is exported to create 3D motion data 30 for each desired animation.

A parallel logic path that follows step 22 includes a step 34 for creating a 2D reference model 36 for each type of avatar, and for each of multiple view or reference angles. The 2D reference model that is initially created, like the 3D reference model, does not include any art assets on any of its multiple views. A step 38 then aligns the 2D and 3D reference models exactly, so that corresponding pivot points in each are aligned. Then, for each specific art asset (e.g., for each pants, skirt, blouse, shoes, hairstyle, etc.), a step 40 provides for drawing the art asset over the appropriate parts of the 2D reference model in all of the views and for the type of avatar for which the art asset is intended to be used. For an avatar, the art assets include different types and styles of clothing and different facial features, such as different hairstyles, noses, eyes, head shape, etc. Thus, each of the articles of clothing for a female would be drawn over the associated body parts of the 2D reference model for the female avatar. The result of this step is a plurality of 2D image files 42, including one image file for each body part of the avatar and for each article of clothing or outfit, hairstyle, or other type of art asset. Finally, step 32 provides for using the 2D reference models, the 2D image files, and the 3D motion data at runtime. The 3D motion data for each body part are then mapped to the 2D image data for the mapped position, rotation, and layer. The concept of layers applies particularly to art assets comprising articles of clothing, which are typically worn in layers. For example, a coat that is worn will cover much of a blouse or shirt, and part of a skirt or pants. Similarly, when a body part moves during the animation so that the moving body part overlaps another body part, the body part (and the art asset drawn on the body part) that is closer to a view point of the user can hide a portion of another body part that is further from the view point. Thus, when an arm is moved in front of an avatar, the clothing drawn on the arm and the portion of the arm that is visible will hide portions of the avatar and clothing drawn thereon that are further from the viewpoint of a user.

### Examples Illustrating the Steps of the Novel Approach

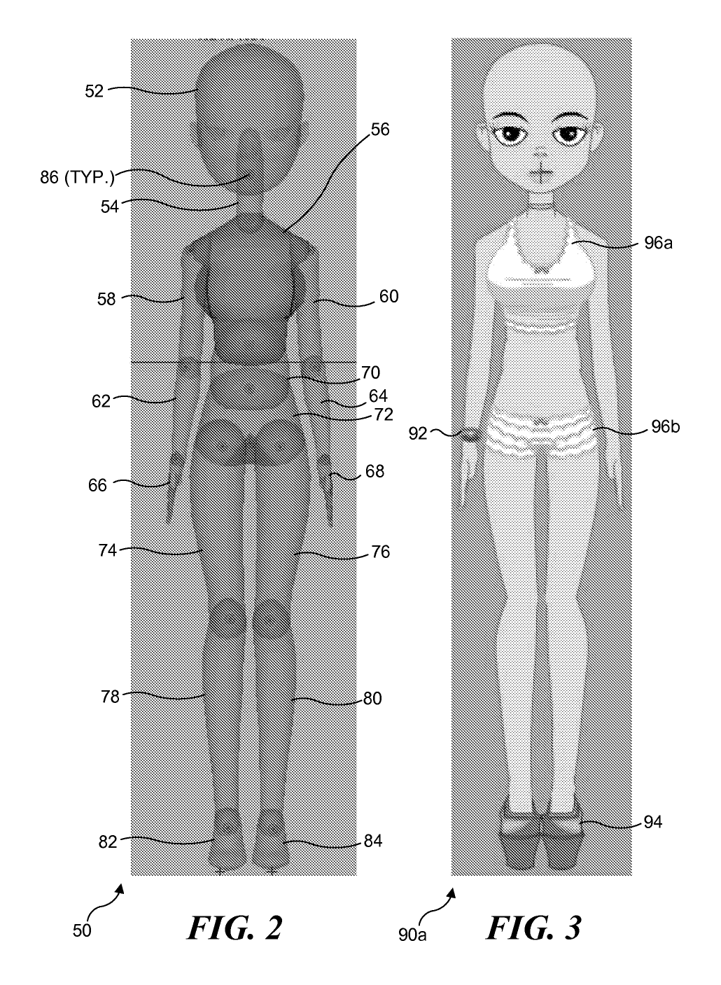

FIG. 2 illustrates an exemplary 3D model 50 of a female avatar. This 3D model is a simple wire-frame and has a number of body parts, including a head 52, a neck 54, an upper chest or torso 56, upper right and left arms 58 and 60, lower right and left arms 62 and 64, right and left hands 66 and 68, an abdomen 70, a pelvis 72, upper right and left legs 74 and 76, lower right and left legs 78 and 80, and right and left feet 82 and 84. Each of the body parts is joined to one or more other body parts at pivot points, such as a pivot point 86, where head 52 is pivotally connected to neck 54. Each body part in the 3D reference model is assigned one of the pivot points, which is the point about which that body part is allowed to rotate. A given body part position in space is defined by knowing where its pivot point is located and how that body part is rotated (either in 2D or 3D space depending on the model type). These pivot points thus indicate where movement of each body part can occur during an animation of the avatar represented by 3D reference model 50.

A front view 90a of a 2D reference model corresponding to 3D reference model 90 is illustrated in FIG. 3. All of the same body parts in the 3D reference model are also included in the 2D reference model, but the 2D reference model is rendered so that the body parts appear continuously joined together, i.e., in a more natural appearance. Also, in this exemplary 2D reference model, a halter top 96a and panties 96b are included as some of the articles of clothing that might be provided. The skin of the 2D reference model can be considered a base layer. This exemplary 2D reference model is also shown wearing an optional bracelet 92 and shoes 94, which are examples of other articles that can be selected to customize an avatar. As an option (for the sake of modesty), every animation of this exemplary female avatar might include at a minimum, halter 96a, and panties 96b, but these articles of clothing are not required and might be replaced with alternative similar types of clothing. It should be clearly understood that any of a number of different art assets comprising articles of clothing and various facial features can be selectively applied to the 2D reference model to change its appearance and customize it as the user prefers. When rendering a shirt with long sleeves the skin layer for the arms can be removed, i.e., a portion of the upper arm on which skin is not visible can be removed. The skin on the lower arm from the elbow to the wrist could also be removed and replaced by a shirt sleeve with only a part of the wrist showing—i.e., this part of the wrist can actually be drawn at the end of the shirt sleeve when rendering the shirt on the avatar. The bracelet is also treated as an item of clothing and is drawn in a separate layer (attached to the wrist) so it can be overlaid over different arms/different color of skins/shirts. Alternatively, when the avatar is rendered in the limited environment, it would be possible to continue drawing the underlying skin layer; however, it the skin layer is going to be completely covered, it is generally more efficient to remove it.

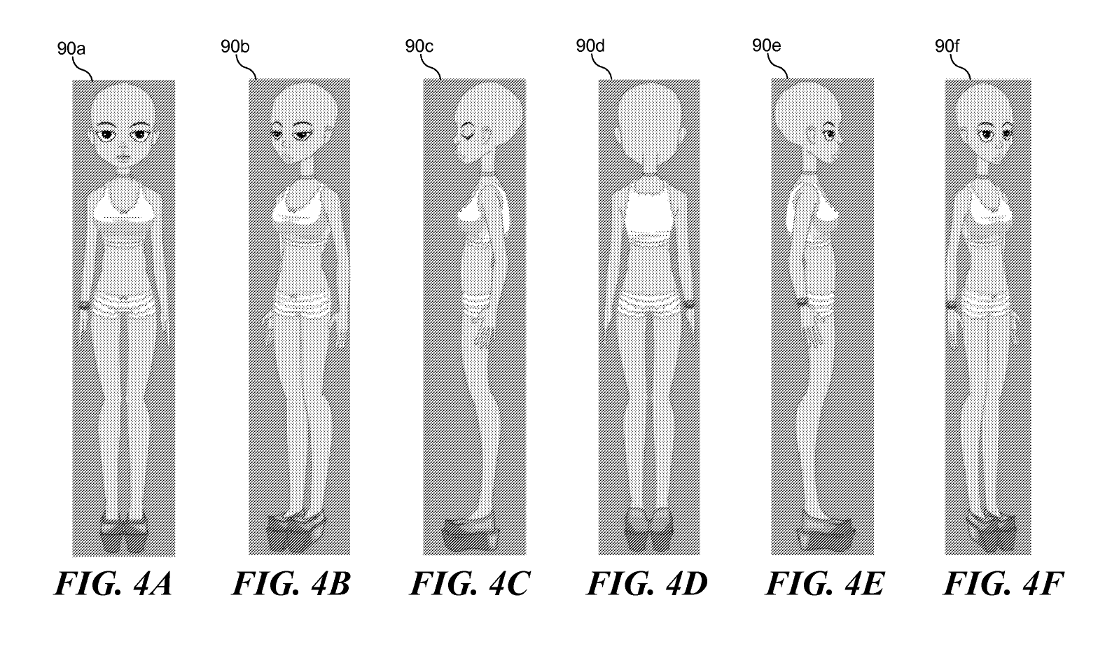

FIGS. 4A-4F respectively illustrate the six different views or reference angles of the exemplary 2D reference model, including front view 90a (FIG. 4A), a ¾ left view 90b (FIG. 4B), a left side view 90c (FIG. 4C), a rear view 90d (FIG. 4D), a right side view 90e (FIG. 4E), and a ¾ right view 90f (FIG. 4F). It should be understood that if more views are included, the animations of the 2D reference model will appear smoother, since successive frames can then show the 2D reference model with greater resolution as it rotates about a vertical axis extending through the center of the 2D reference model. Accordingly, it is not intended that the present novel approach be limited to six different views of the 2D reference model, but instead, either more or fewer different views can be employed for the 2D reference model. When art assets are drawn on the appropriate body parts of the avatar, they are drawn on each of these different views, so that as the 2D model is shown in different orientations or rotational positions in the frames of an animation, the appearance of each art asset applied to the body parts is visible for that orientation of the 2D reference model. Accordingly, as the number of different views is increased, the burden of drawing the different art assets on the appropriate associated body parts for each view increases.

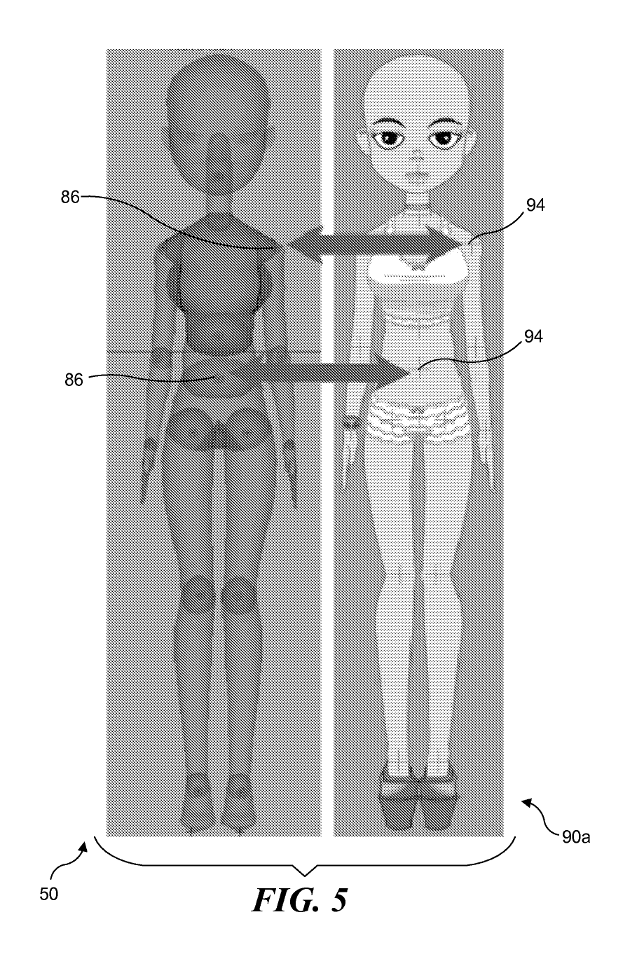

There must be an exact correspondence between the 3D reference model and the 2D reference model for a specific type of avatar or graphic object. This requirement is visually evident in FIG. 5, which shows that each pivot point 86 in the 3D reference model (only two pivot points are indicated with reference numbers) is vertically aligned with a corresponding pivot point 94 in front view 90a of the 2D reference model (and similarly, in all of the other different views of the 2D reference model). It is essential that each pivot point correspond exactly between the 2D and 3D models, so that when the 3D model is projected onto a 2D plane for a corresponding view of the 2D reference model, the pivot points overlap exactly. Accordingly, it will be apparent that any pivotal movement of one of the body parts that is implemented in the 3D reference model can be carried out in precisely the same manner by that body part of the 2D reference model (and in the appropriate view of the multiple views of the 2D reference model).

One of the readily available 3D animation software programs is used to animate the 3D reference model for each desired animation, as noted above. The 3D animation software tool is able to produce very high quality and realistic animations. Modeling constraints are applied (e.g., a requirement that arms bend at the elbow and shoulder but not in between), and the 3D animation software tool computes realistic motion paths (e.g., by using an inverse kinematic algorithm to determine how to move a knee such that when the avatar is walking, each foot is placed correctly on the floor). The resulting animation is represented as a successive series of key frames that define the location of each body part at specific points in time during an animation. The resulting animation is exported from the 3D animation software tool as a stream of 3D data defining exactly how each part of the avatar's body moved during the animation. This data stream is limited to essentially one data point (a 3D location) and a rotation per body part per each frame of a given animation, e.g., one data point indicating where the right wrist is located in each frame during the animation. Each of the desired animations implemented by the 3D animation tool thus produces a 3D motion data file that includes a series of 3D data points, each comprising x,y,z coordinates for one of the pivot points, together with information about how the corresponding body part is rotated in 3D space in each of the frames.

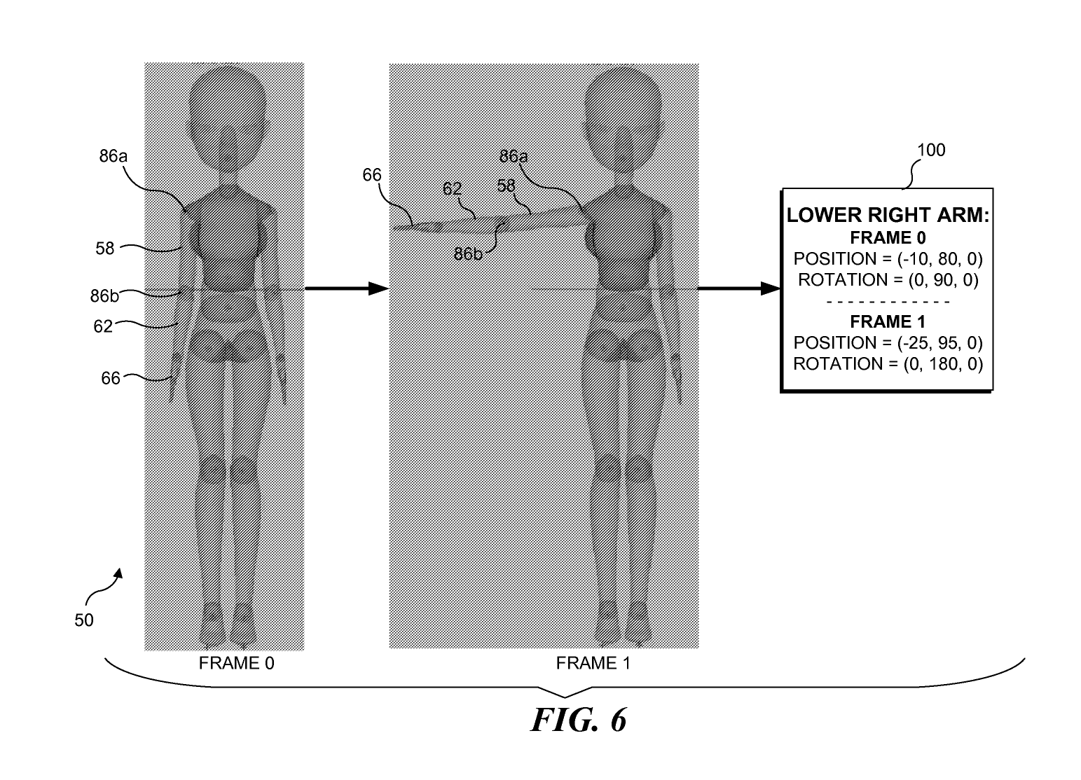

FIG. 6 illustrates the first two frames of an exemplary animation in which the avatar simply raises its right arm from an initial position where the hand is next to the right hip in frame 0, to an outstretched position in frame 1, with the arm extending outwardly from the shoulder. For example, if the animation involves the avatar waving goodbye, several more frames that are not shown would be required to complete the animation. The movement in the first two frames is represented by the motion of upper right arm 58, which pivots about a pivot point 86a where the upper arm connects to the upper torso, but also involves the movement of lower right arm 62 and right wrist 66, neither of which move about their pivot points between frames 0 and 1. Accordingly the change in position of pivot point 86b from (−10, 80, 0) to (−25, 95, 0) between frame 0 and frame 1, and the rotation of upper arm 58 from an orientation (0, 90, 0) to an orientation (0, 180, 0) are sufficient data to define this movement occurring in the first two frames of the animation. The resulting motion data shown in block 100 for position and rotation thus represent the first portion of the 3D motion data file for this animation.

One of the advantages of the present approach is that it enables a user to customize the appearance of a graphic object such as an avatar, by selecting among a plurality of many different art assets that change the appearance of the graphic object. In regard to an avatar, for example, a user can choose from among many different types and styles of articles of clothing to change the appearance of the user's avatar. Thus, a user might be presented with an option to choose among a number of different styles of hats, shirts or blouses, pants or skirts, coats, etc. Since it is not necessary to draw each frame of the animation showing the avatar wearing each possible combination of these different articles of clothing, the tremendous overhead used in that conventional approach is avoided. Instead, the present approach only requires that art asset images be prepared before runtime, in which each article of clothing in the available options is drawn on the appropriate body part(s) of the 2D reference model of the avatar, for each of the plurality of views of the 2D reference model. Some articles of clothing only change the appearance of a few body parts, and only need to be drawn on the body parts affected when that article of clothing is selected to be worn by the avatar. For example, a hat or a hairstyle, which changes the appearance of the avatar's head, is drawn to position it on the head, for all of the plurality of different views of the 2D reference model. Thus, in the rear view, the rear view of the hairstyle would be drawn on the 2D reference model, and similarly, for each of the other views.

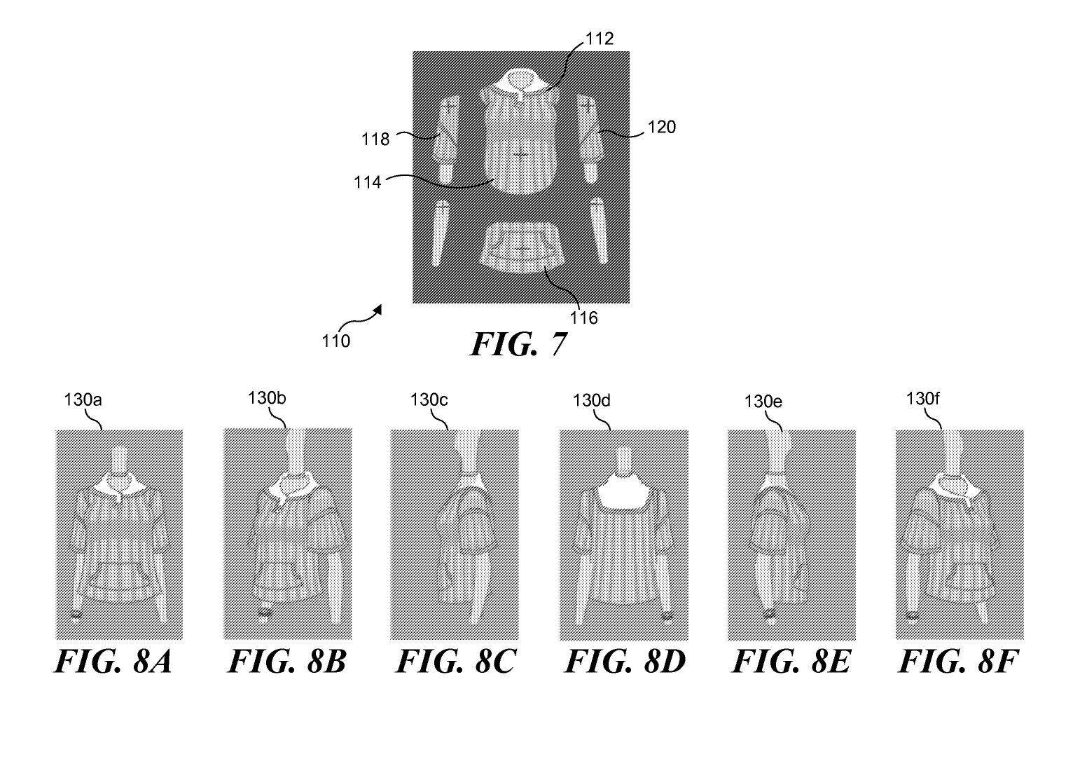

FIG. 7 illustrates clothing parts 110 for a blouse 112 that might be selected by a user as an article of clothing to be worn by a female avatar. Blouse 112 is applied to (i.e., drawn on) several different body parts to change their appearance. Right and left sleeves 118 and 120 of the blouse change the appearance of the right and left upper arms of the avatar, while a main body 114 of the blouse changes the appearance of the upper torso of the avatar, and a lower portion 116 of the blouse changes the appearance of the avatar's abdomen. Clothing parts 110 are thus aligned to match the corresponding body parts of the 2D reference model that they at least partially cover. The image file for each body part on which the blouse appears is then saved as a series of separate 2D image files, one per body part, for that particular blouse art asset. The crosses on FIG. 7 show the location of the pivot points for each body part. Also, as shown in FIGS. 8A-8F, the blouse must be drawn with all of its parts aligned with the corresponding body parts of the avatar in each of the different views of the 2D reference model. These Figures show an assembled collection of image files for each, since the image files each correspond to a body part rather than the entire blouse. Thus, the blouse is drawn on the body parts of the avatar in a front view 130a (FIG. 8A), a ¾ left view 130b (FIG. 8B), a left side view 130c (FIG. 8C), a rear view 130d (FIG. 8D), a right side view 130e (FIG. 8E), and a ¾ right view 130f (FIG. 8F).

### Rendering and Displaying an Animation in 2D Space at Runtime

The preparation of the 3D motion data for each desired animation and of the 2D art asset image files for the various articles of clothing or other art assets that can optionally be applied to customize the appearance of the avatar is completed before the animation is to be rendered and displayed in the 2D environment that lacks 3D animation rendering capability. When a user has connected to a website that provides access to the 3D motion data and art asset image files, the user can make selections from among all of the available art assets to customize the appearance of the avatar. The selections of the user can cause the images files for those specific articles of clothing to then be downloaded to the limited environment, such as to the web browser program that the user is employing to connect to the website. Also downloaded will be the 3D motion data files for each animation the avatar might perform, as well as XML or script files that define how the browser program will use the 3D motion data and art asset files to display a 3D animation. One of the available animations can be selected by a user and played back within the browser program display using the 3D motion data for the type of avatar of the user and the image files for the various articles of clothing (all of the different views) selected by the user to customize the user's avatar. The playback of the animation is accomplished by interpreting the 3D motion data and computing where each body part should be drawn in 2D. The 3D motion data also indicate how a body part is rotated, and that information is used to determine the view or reference angle that should be used for that particular body part. For example, the 3D motion data determines whether the front of the right arm or the back of the right arm should be rendered and displayed with the appropriate clothing (i.e., selected art asset image) appearing on the arm (it will be understood that this determination can change during an animation as the arm moves). The appropriate piece of clothing for that body part from the art asset image files is displayed at the computed 2D location indicated by the 3D motion data for each successive frame of the animation, which are displayed in rapid sequence to produce the perceived movement of the avatar.

The choice of the particular article of clothing to render (e.g., which shirt or pants will be worn by the avatar) is completely independent of the task of determining how to render a particular image of the avatar, other than as a way of determining the art asset files that will be used to change the appearance of the body parts of the avatar. Thus, new articles of clothing can be created to increase the number of articles of clothing from which users can choose, and art asset image files can then be drawn for each new article of clothing. The new article of clothing selected by a user for an avatar will automatically render in the correct locations to produce the desired animation defined by the 3D motion data. This playback of the animation frames in 2D space only requires computing where in 2D space each body part will be rendered (i.e., translating each single point from 3D to 2D for each body part) and then rotating and drawing the original 2D image of the selected art asset as applied to that body part. This approach makes the process of displaying the animations computationally feasible in limited environments, such as inside a web browser program.

Details of exemplary steps for displaying an animation of an avatar or other graphic object at runtime are provided in a flowchart 140 shown in FIG. 9. The procedure starts at a step 142 in which a “local camera position,” focal point, and focal length are selected in 3D space. A step 144 determines the avatar's position in 3D space before it can be rendered in the limited environment. This position represents the difference between the position of the avatar and the position of the camera or view point at which the animation is viewed and defines how the projection from 3D to 2D space will occur. Next, a step 146 selects each animation frame to be drawn in sequence to provide the animation. Typically, successive frames are drawn with about 1/30 or 1/15 second elapsing between frames, depending on the frame rate of the animation rendering in 2D space. It should be understood that the frame rate at which the 3D motion data for the animation was created by the 3D animation software tool is generally independent of the frame rate at which the animation is rendered within the limited environment. If a higher frame rate was used when the 3D motion data were created, frames can be skipped to achieve a lower frame rate in the 2D space rendering, which might occur, for example, if the 2D rendering cannot keep up with the frame rate at which the 3D motion data were created. Conversely, in the 2D space, it is possible to interpolate between frames created by the 3D animation rendering software tool when producing the 3D motion data, to create intermediate frames that are displayed in the 2D space.

A step 148 provides for selecting each body part of a frame in turn and calculating the position and rotation of the body part, so that each body part can move and rotate independently of any other body parts of the avatar. A step 150 provides for reading the location (a,b,c) and rotation (u,v,w) of the pivot point for each body part from the 3D motion data file for the current animation. Next, a step 152 projects from the positions (a,b,c) in 3D space to (x,y) in 2D screen coordinates and determines in which layer the body part should be drawn, i.e., in a layer closer to the camera or view point of the user or in a layer further from the camera/view point. Similarly, a step 154 uses the rotation information for each body part that is included in the 3D motion data file, together with the angle from the camera/view point position to the body part to determine the closest one of the multiple views or reference angles of the 2D reference model to draw. For example, if the body part is directly facing the camera position, then the front view of the 2D reference model is used. If the body part is partially turned to the right of the camera position, then the right 3/4 view of the 2D reference model is used, etc. This step enables an animation to start by showing one side of a body part (e.g., the front of an arm) and then as the animation progresses, showing a different side of that same body part (e.g., the back of the arm).

A step 156 computes an affine transformation matrix from the position and rotation information for the current body part that is applied to the 2D body part image. The distance from the camera point or view point to the body part can also be used to scale the body part, if desired, to produce a sense of depth, if different avatars are rendered in 2D at different distances from the camera point. As those of ordinary skill in computer graphics will understand, an affine transformation is a linear set of transformations (rotations, scaling, shearing, and linear translation) that can be described by a matrix. Many graphics libraries support using affine transformations for rapid image manipulation. Affine transformations are used when drawing 2D image files to efficiently in the present novel procedure, to more readily rotate, scale and translate the 2D image files (for the art assets applied to each body part) on the display screen. A decision step 158 determines if all affine transformations have been computed for all of the body parts of the avatar for the current frame. If not, the logic returns to step 148 to process the next body part in the current frame. Otherwise, the logic proceeds with a step 160, which provides for sorting all of the body parts based upon the distance from the camera position or view point to the pivot points of the body parts, which is determined in a single calculation for each body part in the current frame.

A step 162 selectively renders the body parts in the frame, in order from the furthest body part (i.e., the body part that is further away from the camera position) to the nearest. This step ensures that body parts that are nearer to the camera position or view point are drawn in front of any body part that is further from the camera position. A step 164 draws the 2D image for the current body part and view or reference angle of the 2D reference model that was selected in step 154, with the body part rotated and positioned as defined by the affine transformation matrix. The resulting image is thus at the correct location on the display and rotated to match the 3D motion data for the current frame. A decision step 166 determines if all body parts for the current layer have been drawn, and if not returns to step 162 to process the next body part in the current layer.

An affirmative response to decision step 166 leads to a decision step 168, which determines if all layers in the current frame have been drawn, and if not, loops back to step 146. If the response is in the affirmative, the logic proceeds with a decision step 170, which determines if all frames of the current animation have been drawn. If not, the logic also loops back to step 146 to process the next successive frame of the automation. Otherwise, the logic is complete, and the animation will have been rendered and displayed in the 2D space of the limited environment.

### Exemplary Computing System for Implementing the Procedure

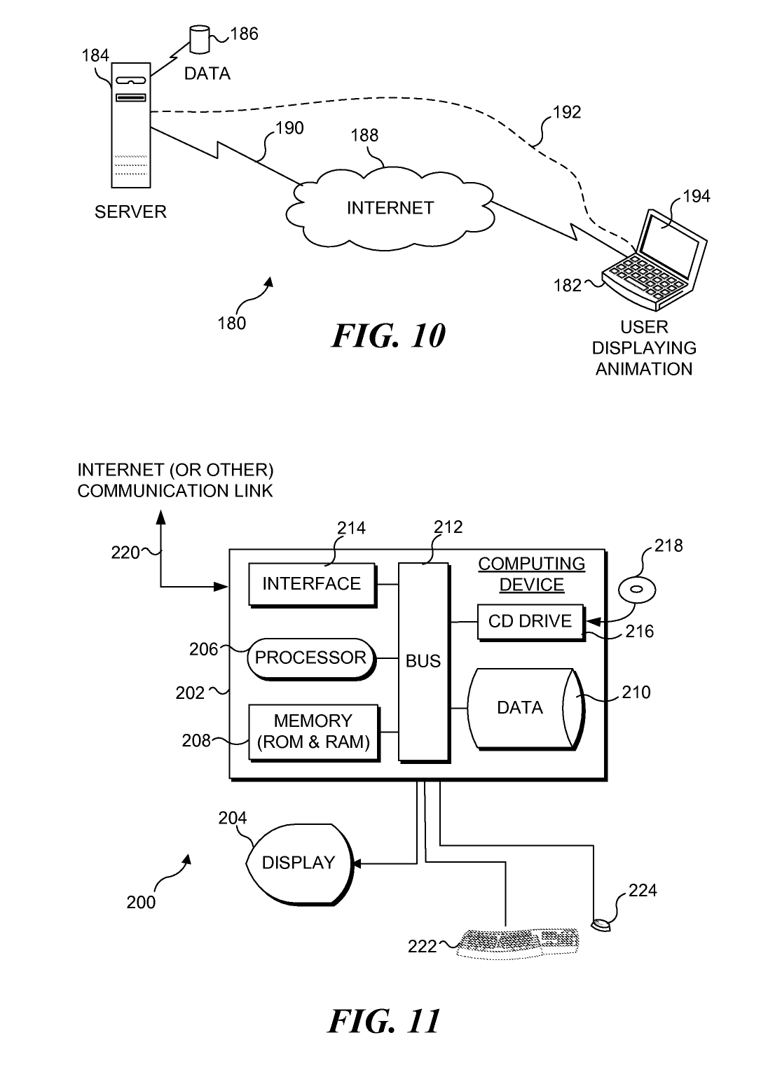

An initial application of the present novel procedure will enable a user to access a web site where the prepared 3D motion data and image files for the art assets (e.g., image files for different articles of clothing and hairstyles) are available for use in rendering an animation of an avatar customized by the user to appear with selected articles of clothing and hairstyle within the browser program. Accordingly, FIG. 10 illustrates a diagram showing a system 180 that includes a user laptop computer 182 (or other personal computing device, such as a personal data assistant, smart telephone, or desktop computer system) connected to a remote server 184 through Internet 188, using wired and/or wireless connection 190. This connection can be through a cable modem, dial-up connection, DSL connection, wi-fi connection, WiMax connection, satellite connection, or through any other available communication link that enables data to be passed between the server and the user computer. Alternatively, on a local or wide area network, the server might be coupled by an Ethernet connection 192 or other suitable communication link, in data communication with the user computer. Server 184 provides a web page and the prepared 3D motion data for each desired animation to be run on the user computer and the image files for each selected art asset to be used in the animation, when the user connects the user's computing device to the server for this purpose, for example, by using a browser software program that couples to a uniform resource location (URL) of the server over the Internet. The user's computer then runs the animation with the 3D motion data and the image files for the selected art asset for each animation that is to be displayed in the browser software program in a display screen 194 on the user's computer.

FIG. 11 illustrates a functional block diagram 200 showing the components of the server or of a typical computing device that might be employed by a user to connect to a server, as described above. A computing device 202 is coupled to a display 204 and includes a processor 206, a memory (read only memory (ROM) and random access memory (RAM)) 208, and a non-volatile data store 210 (such as a hard drive, or other non-volatile memory). A bus is provided to interconnect internal components such as the non-volatile data storage, and the memory to processor 206. Optionally, a CD or other optical disc drive may be included for input of programs and data that are stored on an optical memory medium 218, or for writing data to the writable optical medium with the optical drive. An interface 214 couples computing device 202 through a communication link 220 to the Internet or other network. Bus 212 also couples a keyboard 222 and a mouse (or other pointing device) 224 with processor 206, and the keyboard and pointing device are used to control the computing device and provide user input, as will be well known by those of ordinary skill in the art. Non-volatile data storage 210 can be used to store machine executable instructions that are executable by processor 206 to carry out various functions. For example, if computing device 202 comprises server 184 (FIG. 10), then the machine instructions might cause processor 206 to carry out the steps necessary to prepare the 3D motion data files and the art asset image files, which can then be stored on the non-volatile data storage, or on an external data storage 186 (as shown in FIG. 10). The 3D animation software tool might also be stored as machine instructions on non-volatile data storage 210.

If computing device 202 comprises the user's computer, then non-volatile data storage will store machine instructions corresponding to the browser program that is used to access the web page and download the 3D motion data and art asset image files for the selected articles of clothing and hairstyle of the user's avatar. The web page that is downloaded from the server can include XML, or script files that control the display and rendering of the avatar in an animation within the browser program. In a current exemplary embodiment, Flash action scripts are used to control the display and rendering of animations in the browser program, but is not intended to be limiting, since other techniques can clearly be used. As a further alternative, other types of limited environments can provide the machine instructions for rendering and display of animations, as discussed above.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for enabling animations of a graphic object, which can have multiple different visual appearances, to be displayed in a two-dimensional (2D) form in an environment lacking support for a high quality real-time three-dimensional (3D) rendering of an animation of the graphic object, the graphic object comprising a plurality of associated parts to which different art assets can be selectively applied to change the appearance of the graphic object, the method comprising the steps of:
(a) prior to displaying any animations in the environment lacking support for high quality real-time 3D animation rendering:
(i) creating a 3D reference model for the graphic object;
(ii) creating a 2D reference model for the graphic object corresponding to the 3D reference model, in multiple views, each of the multiple views of the 2D reference model being from a different direction;
(iii) aligning the 2D reference model and the 3D reference model with each other;
(iv) creating 3D motion data for each animation of the graphic object desired, using the 3D reference model, each animation comprising a plurality of frames; and
(v) for each art asset that might be displayed on the graphic object, providing 2D image files for all of the multiple views of the associated parts of the 2D reference model, with the art assets appearing on the associated parts on which they might be displayed; and
(b) when displaying an animation selected from the desired animations for which the 3D motion data were created in the environment:
(i) mapping the 3D motion data for each associated part of the graphic object in each frame of the animation, to a corresponding 2D location in the frame; and
(ii) rendering successive frames of the animation selected, so that for each frame of the animation selected, the associated parts of the 2D reference model of the graphic object are displayed with the art assets applied, at a mapped position and at a mapped rotation for the frame.

2. The method of claim 1, further comprising the step of enabling a user to select different portions of the art assets to be displayed on specific associated parts of the 2D reference model of the graphic object, each selection of different portions of the art assets customizing an appearance of the graphic object when the animation is displayed in the environment.

3. The method of claim 2, wherein the art assets are displayed on the associated parts in different layers, further comprising the step of hiding an area of one art asset on one layer with an art asset that is displayed on a different layer that is closer to a view point of the animation selected than the one layer.

4. The method of claim 3, further comprising the step of applying the art assets to an associated part of the graphic object in different layers, the different layers being ordered in regard to the view point, so that the art asset applied to an associated part on a layer closer to the view point hides at least part of an art asset applied to the associated part on a layer further from the view point.

5. The method of claim 1, wherein for each frame of the animation being displayed, the step of displaying further comprises the steps of:
(a) identifying a view point for the animation selected in 3D space;
(b) determining a position of the graphic object in 3D space;
(c) for each associated part of the graphic object in succession:
(i) inputting the location and the rotation of the associated part from the 3D motion data;
(ii) projecting coordinates in 3D space for the associated part into 2D space, to determine a layer in which the associated part should be displayed in the environment;
(iii) using the rotation for the associated part to determine a closest view of the multiple views, for the associated part; and
(iv) determining an affine transformation matrix from the position and the rotation for the associated part;
(d) sorting the associated parts and the layers in which the associated parts are disposed, based on a distance between the associated parts and the view point; and
(e) for each layer in succession, displaying the associated parts of the graphic object in the layer with selected art assets applied starting with the layer that is furthest from the view point, using the affine transformation matrix to determine the position and the rotation of each associated part in the layers.

6. The method of claim 1, wherein the graphic object comprises an avatar, and wherein the art assets include a plurality of types and articles of clothing that are different in appearance and which can be selected to customize an appearance of the avatar when rendered and displayed as the 2D graphic object in the environment.

7. The method of claim 6, wherein the art assets further include a plurality of different facial features from one or more can be selected to further customize the appearance of the avatar.

8. The method of claim 6, further comprising the step of enabling a new article of clothing to be added to the art assets for use in displaying any animation selected from the desired animations, without modifying the 3D motion data.

9. The method of claim 1, further comprising the step of enabling new animations to be employed to create additional 3D motion data for use with any of the art assets.

10. The method of claim 1, wherein the environment lacking support for high quality real-time 3D rendering comprises a browser program.

11. A memory medium on which are stored machine instructions for enabling animations of a graphic object, which can have multiple different visual appearances, to be displayed in a two-dimensional (2D) form in an environment lacking support for high quality real-time three-dimensional (3D) rendering of an animation of the graphic object, the graphic object comprising a plurality of associated parts to which different art assets can be selectively applied to change the appearance of the graphic object, the machine executable instructions being executable to carry out a plurality of functions, including:
(a) accessing 3D motion data that were previously generated for each of a plurality of associated parts of the graphic object in regard to each of a plurality of frames of the animation;
(b) accessing art assets that were selected for application to the associated parts of the graphic object when displayed as a 2D graphic object in the environment;
(c) mapping the 3D motion data for each associated part of the graphic object in each frame of the animation, to a corresponding 2D location in the frame within the environment; and
(d) rendering successive frames of the animation in rapid succession to produce a perceived movement of the graphic object in the animation, so that for each frame, the associated parts of the graphic object are displayed in a 2D form in the environment, with the art assets selected applied to the associated parts of the graphic object, at a mapped position and at a mapped rotation for the frame.

12. The memory medium of claim 11, wherein for each frame of the animation, the machine instructions are further executable to carry out the functions of:
(a) identifying a view point for the animation in 3D space;
(b) determining a position of the graphic object in 3D space;
(c) for each associated part of the graphic object in succession:
(i) accessing the location and the rotation of the associated part in the 3D motion data;
(ii) projecting coordinates in 3D space for the associated part into 2D space, to determine a layer in which the associated part should be displayed in the environment;
(iii) using the rotation to determine a closest reference angle of view for the associated part; and
(iv) determining an affine transformation matrix from the position and the rotation for the associated part;
(d) sorting the associated parts and the layers in which the associated parts are disposed, based on a distance between the associated parts and the view point; and
(e) for each layer in succession, displaying the associated parts of the graphic object in the layer, using the affine transformation matrix to determine the position and the rotation of each associated part in the layer, with the art assets applied to the associated parts.

13. The memory medium of claim 11, wherein the graphic object comprises an avatar, and wherein the art assets include a plurality of types and articles of clothing that are different in appearance, the machine instructions being executable to further enable a user to select different specific articles of clothing from among the art assets to customize an appearance of the avatar when rendering and displaying the avatar in the environment as the 2D graphic object.

14. The memory medium of claim 11, wherein the art assets further include a plurality of different facial features, the machine instructions being executable to further cause the processor to enable a user to select one or more facial features that can be applied to the avatar from among the plurality of different facial features, to further customize the appearance of the avatar when displayed in the environment as the 2D graphic object.

15. The memory medium of claim 11, wherein the environment lacking support for high quality real-time 3D rendering of an animation comprises a browser software program with which the machine instructions interact, so that the animation is displayed using the browser program.

16. A system for use in enabling animations of a graphic object, which can have multiple different visual appearances, to be displayed in a two-dimensional (2D) form in an environment lacking support for high quality real-time three-dimensional (3D) rendering of the graphic object, the graphic object comprising a plurality of associated parts to which different art assets can be selectively applied to change the appearance of the graphic object, the system comprising:
(a) a memory in which are stored machine instructions and data;
(b) a display for displaying graphics and text;
(c) an input device for providing an input for controlling the system; and
(d) a processor that is coupled to the memory, the display, and the input device, the processor executing the machine instructions to carry out a plurality of functions, including:
(i) creating a 3D reference model for the graphic object;
(ii) creating a 2D reference model for the graphic object corresponding to the 3D reference model, in multiple views, each of the multiple views of the 2D reference model being from a different direction;
(iii) aligning the 2D reference model and the 3D reference model with each other;
(iv) creating 3D motion data for each frame of each animation of the graphic object desired, using the 3D reference model, each animation comprising a plurality of frames;
(v) for each art asset that might be displayed on the graphic object, providing 2D image files for all of the multiple views of the associated parts of the 2D reference model, with the art assets appearing on the associated parts on which they might be displayed in the 2D image files; and
(vi) storing the 3D motion data and the image files of the art assets in the memory for subsequent use in rendering the animation in the 2D form in the environment.

17. The system of claim 16, wherein the processor executes a separate software program to create the 3D motion data for each frame of each animation of the graphic object desired.

18. A system for enabling animations of a graphic object, which can have multiple different visual appearances, to be displayed in a two-dimensional (2D) form in an environment lacking support for high quality real-time three-dimensional (3D) rendering of the graphic object, the graphic object comprising a plurality of associated parts to which different art assets can be selectively applied to change the appearance of the graphic object, the system comprising:
(a) a memory in which are stored machine instructions and data;
(b) a display for displaying graphics and text;
(c) an input device for providing an input for controlling the system; and
(d) a processor that is coupled to the memory, the display, and the input device, the processor executing the machine instructions to carry out a plurality of functions, including:
(i) for each frame of the animation, identifying a view point for the animation in 3D space;
(ii) for each frame of the animation, determining a position of the graphic object in 3D space;
(iii) in each frame of the animation, for each associated part of the graphic object of the frame in succession:
(A) accessing 3D motion data that have been previously determined for the graphic object, to determine a location and a rotation of the associated part in 3D space;
(B) projecting coordinates in 3D space that were obtained from the 3D motion data for the associated part into 2D space, to determine a layer in which the associated part should be displayed in the environment;
(C) using the rotation of the associated part to determine a closest reference angle of view for the associated part; and
(D) determining an affine transformation matrix from the position and the rotation for the associated part;
(iv) for each frame of the animation, sorting the associated parts and the layers in which the associated parts are disposed, based on a distance between the associated parts and the view point;
(v) for each frame of the animation and for each layer in succession, displaying the associated parts of the graphic object in the layer with selected art assets applied, using the affine transformation matrix to determine the position and the rotation of each associated part in the layer; and
(vi) displaying the frames of the animation in rapid succession, to display the animation in the environment.

19. The system of claim 18, wherein the machine instructions further cause the processor to enable a user to select specific art assets to be applied to the associated parts of the graphic object that will be displayed during the animation in the environment.

20. The system of claim 18, wherein the machine instructions further cause the processor to display the selected art assets in different layers and to hide an area of one art asset on one layer with an art asset that is displayed on a different layer that is closer to the view point of the animation.

21. The system of claim 20, wherein the machine instructions further cause the processor to apply the art assets to an associated part of the graphic object in different layers, the different layers being ordered in regard to the view point, so that the art asset applied to an associated part in a layer closer to the view point hides at least part of an art asset applied to the associated part on a layer further from the view point.

22. The system of claim 18, wherein for each frame of the animation being displayed, the machine instructions further cause the processor to:
(a) identify the view point for the animation in 3D space;
(b) determine a position of the graphic object in 3D space;
(c) for each associated part of the graphic object in succession:
(i) access the location and the rotation of the associated part from the 3D motion data;
(ii) project coordinates in 3D space for the associated part into 2D space, to determine a layer in which the associated part should be displayed in the environment;
(iii) use the rotation for the associated part to determine a closest reference angle of view for the associated part; and
(iv) determine the affine transformation matrix from the position and the rotation for the associated part;
(d) sort the associated parts and the layers in which the associated parts are disposed, based on a distance between the associated parts and the view point in 3D space; and
(e) for each layer in succession, display the associated parts of the graphic object in the layer with selected art assets applied, using the affine transformation matrix to determine the position and the rotation of each associated part in the layer.

23. The system of claim 18, wherein the graphic object comprises an avatar, and wherein the art assets include a plurality of types and articles of clothing that are different in appearance, the machine instructions further causing the processor to enable a user to select different specific articles of clothing from among the art assets to customize an appearance of the avatar when rendering and displaying the avatar in the environment.

24. The system of claim 23, wherein the art assets further include a plurality of different hair styles, the machine instructions being executable to further enable a user to select a hairstyle to be applied to the avatar from among the plurality of different hair styles, to further customize the appearance of the avatar when rendering and displaying the avatar in the environment as the 2D graphic object.

25. The system of claim 18, wherein the environment lacking support for high quality real-time 3D rendering of an animation comprises a browser program defined by machine instructions that are executed by the processor, so that the animation is displayed using the browser program.
